(19) United States
(12) Patent Application Publication
(10) Pub. No.: US 2019/0314983 A1
(43) Pub. Date: Oct. 17, 2019

(54) RECORDING MEDIUM, INFORMATION PROCESSING APPARATUS, AND INFORMATION PROCESSING METHOD

(71) Applicants: SONY CORPORATION, TOKYO (JP); SONY ELECTRONICS INC., PARK RIDGE, NJ (US)

(72) Inventors: JUNJI OTSUKA, KANAGAWA (JP); TAMAKI KOJIMA, SUNNYVALE, CA (US)

(21) Appl. No.: 16/046,485

(22) Filed: Jul. 26, 2018

Related U.S. Application Data
(60) Provisional application No. 62/658,783, filed on Apr. 17, 2018.

(51) Int. Cl. B25J 9/16; G06N 99/00; G06N 5/02

(52) U.S. Cl. CPC B25J 9/163; G06N 99/005; H04N 5/247; B25J 9/1697; B25J 9/1694; G06N 5/022

(57) ABSTRACT

There is provided a recording medium having a program recorded thereon, the program causing a computer to function as: a learning section configured to learn an action model for deciding an action of an action body on a basis of environment information indicating a first environment, and action cost information indicating a cost when the action body takes an action in the first environment; and a decision section configured to decide the action of the action body in the first environment on a basis of the environment information and the action model.

### CROSS REFERENCE TO RELATED APPLICATION

This application claims the benefit of priority of Provisional Application Ser. No. U.S. 62/658,783, Apr. 17, 2018, the entire contents of which are incorporated herein by reference.

### BACKGROUND

The present disclosure relates to a recording medium, an information processing apparatus, and an information processing method.

In recent years, a variety of action bodies such as robotic dogs and drones have been developed that autonomously take actions. Action decisions of the action bodies are made, for example, on the basis of the surrounding environments. From the perspective of the suppression or the like of the power consumption of the action bodies, technology is desired that makes action decisions more appropriately.

For example, US 2015/0112508A discloses technology that relates to the rotation control of a tire of a vehicle, and performs feedback control to reduce the difference between a torque value measured in advance with respect to a slick tire, which prevents a skid from occurring, and a torque value actually measured while traveling.

### SUMMARY

However, the technology disclosed in US 2015/0112508A is difficult to apply to control other than the rotation control of a tire, and moreover, it is feedback control, which is performed after actually travelling. Accordingly, it is difficult in principle to predict a torque value before travelling, and perform rotation control. Therefore, it is difficult for the technology disclosed in US 2015/0112508A to appropriately perform rotation control on a tire in an unknown environment.

Then, the present disclosure provides a mechanism that allows an action body to more appropriately decide an action.

According to an embodiment of the present disclosure, there is provided a recording medium having a program recorded thereon, the program causing a computer to function as: a learning section configured to learn an action model for deciding an action of an action body on a basis of environment information indicating a first environment, and action cost information indicating a cost when the action body takes an action in the first environment; and a decision section configured to decide the action of the action body in the first environment on a basis of the environment information and the action model.

In addition, according to an embodiment of the present disclosure, there is provided an information processing apparatus including: a learning section configured to learn an action model for deciding an action of an action body on a basis of environment information indicating a first environment, and action cost information indicating a cost when the action body takes an action in the first environment; and a decision section configured to decide the action of the action body in the first environment on a basis of the environment information and the action model.

In addition, according to an embodiment of the present disclosure, there is provided an information processing method that is executed by a processor, the information processing method including: learning an action model for deciding an action of an action body on a basis of environment information indicating a first environment, and action cost information indicating a cost when the action body takes an action in the first environment; and deciding the action of the action body in the first environment on a basis of the environment information and the action model.

According to an embodiment of the present disclosure as described above, there is provided a mechanism that allows an action body to more appropriately decide an action. Note that the effects described above are not necessarily limitative. With or in the place of the above effects, there may be achieved any one of the effects described in this specification or other effects that may be grasped from this specification.

### BRIEF DESCRIPTION OF THE DRAWINGS

FIG. 1 is a diagram for describing an overview of proposed technology;

FIG. 2 is a diagram illustrating a hardware configuration example of an autonomous mobile object according to an embodiment of the present disclosure;

FIG. 3 is a block diagram illustrating a functional configuration example of the autonomous mobile object according to the present embodiment;

FIG. 4 is a block diagram illustrating a functional configuration example of a user terminal according to the present embodiment;

FIG. 5 is a diagram for describing an acquisition example of reference measurement information according to the present embodiment;

FIG. 6 is a diagram for describing a calculation example of an evaluation value according to the present embodiment;

FIG. 7 is a diagram for describing a calculation example of an evaluation value according to the present embodiment;

FIG. 8 is a diagram for describing an example of a prediction model according to the present embodiment;

FIG. 9 is a diagram for describing a learning example of a prediction model according to the present embodiment;

FIG. 10 is a diagram for describing an action decision example of the autonomous mobile object according to the present embodiment;

FIG. 11 is a diagram for describing an action decision example of the autonomous mobile object according to the present embodiment;

FIG. 12 is a diagram for describing an action decision example of the autonomous mobile object according to the present embodiment;

FIG. 13 is a diagram for describing a prediction example of an evaluation value by the autonomous mobile object according to the present embodiment;

FIG. 14 is a diagram for describing a learning example of an action model by the autonomous mobile object according to the present embodiment;

FIG. 15 is a diagram illustrating an example of a UI screen displayed by the user terminal according to the present embodiment;

FIG. 16 is a flowchart illustrating an example of a flow of learning processing executed by the autonomous mobile object according to the present embodiment; and

FIG. 17 is a flowchart illustrating an example of a flow of action decision processing executed by the autonomous mobile object according to the present embodiment.

### DETAILED DESCRIPTION OF THE EMBODIMENT(S)

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be made in the following order.

### 1. Introduction

### 2. Configuration Examples

### 2.1. Hardware Configuration Example of Autonomous Mobile Object

### 2.2. Functional Configuration Example of Autonomous Mobile Object

### 2.3. Functional Configuration Example of User Terminal

### 3. Technical Features

### 3.1. Acquisition of Measurement Information

### 3.2. Actual Measurement of Evaluation Value

### 3.3. Prediction of Evaluation Value

### 3.4. Decision of Action

### 3.5. Learning of Action Model

### 3.6. Reflection of Request of User

### 3.7. Update Trigger

### 3.8. Flow of Processing

### 3.9. Supplemental Information

### 4. Conclusion

### 1. INTRODUCTION

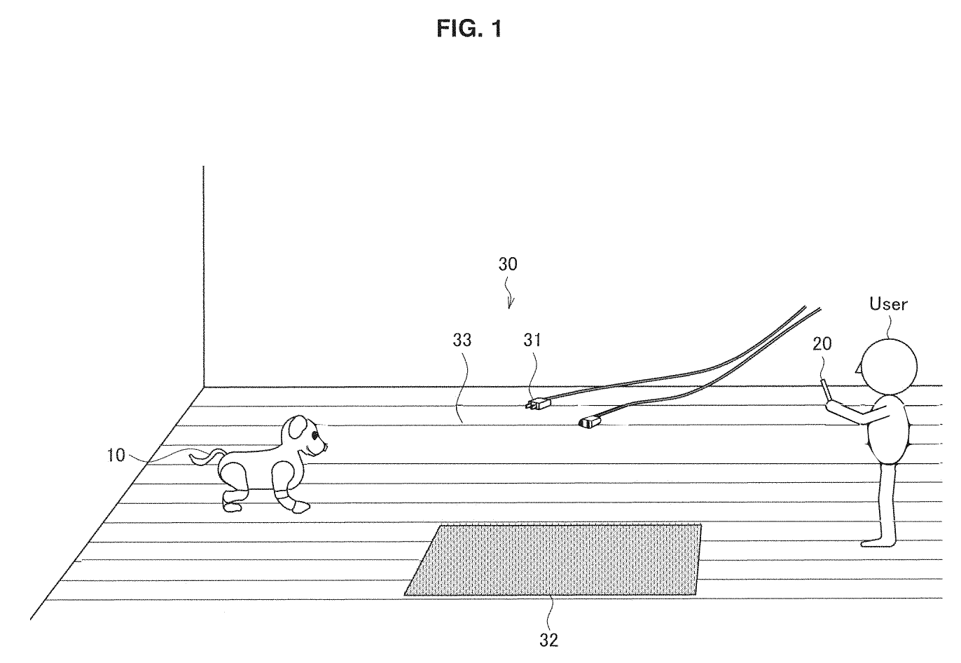

FIG. 1 is a diagram for describing the overview of proposed technology. In a space 30 illustrated in FIG. 1, there is an autonomous mobile object 10 and a user who operates a user terminal 20. The autonomous mobile object 10 is an example of an action body. The autonomous mobile object 10 moves on a floor as an example of an action. Here, the movement is a concept including rotation or the like to change a moving direction in addition to a position change. The autonomous mobile object 10 can be implemented as any apparatus such as a bipedal humanoid robot, a vehicle, or a flying object in addition to the quadrupedal robotic dog illustrated in FIG. 1. The user terminal 20 controls an action of the autonomous mobile object 10 on the basis of a user operation. For example, the user terminal 20 performs setting about an action decision of the autonomous mobile object 10. The user terminal 20 can be implemented as any apparatus such as a tablet terminal, a personal computer (PC), or a wearable device in addition to the smartphone illustrated in FIG. 1.

The action easiness of the autonomous mobile object 10 depends on an environment. In an environment where it is difficult to move, it takes time to move, it is not possible to move in the first place, or more power is consumed. For example, the floor of the space 30 is a wooden floor 33, and it is easy to move. However, in an area including a cable 31 or an area of a carpet 32, it is difficult to move. In the area of the wooden floor 33, the amount of movement per unit time is large, and the amount of consumed power is small. Meanwhile, in the area including the cable 31 or the area of the carpet 32, the amount of movement per unit time is small, and the amount of consumed power is large.

Here, if it is possible to predict action easiness in advance, it is possible to achieve efficient movement. Meanwhile, it is difficult to define all various real environments (types of floors and rugs, patterns of obstacles, and the like) in advance. Moreover, action easiness is influenced by not only an environment, but also the deterioration of the autonomous mobile object 10 over time, a change in an action method, and the like.

Then, the present disclosure proposes technology that allows the autonomous mobile object 10 to appropriately decide an action even in an unknown environment. According to an embodiment of this proposed technology, the autonomous mobile object 10 is capable of predicting action easiness in advance even in an unknown environment, selecting a route on which it is easy to take an action, and moving.

### 2. CONFIGURATION EXAMPLES

### <2.1. Hardware Configuration Example of Autonomous Mobile Object>

Next, a hardware configuration example of the autonomous mobile object 10 according to an embodiment of the present disclosure will be described. Note that the following describes, as an example, the case where the autonomous mobile object 10 is a quadrupedal robotic dog.

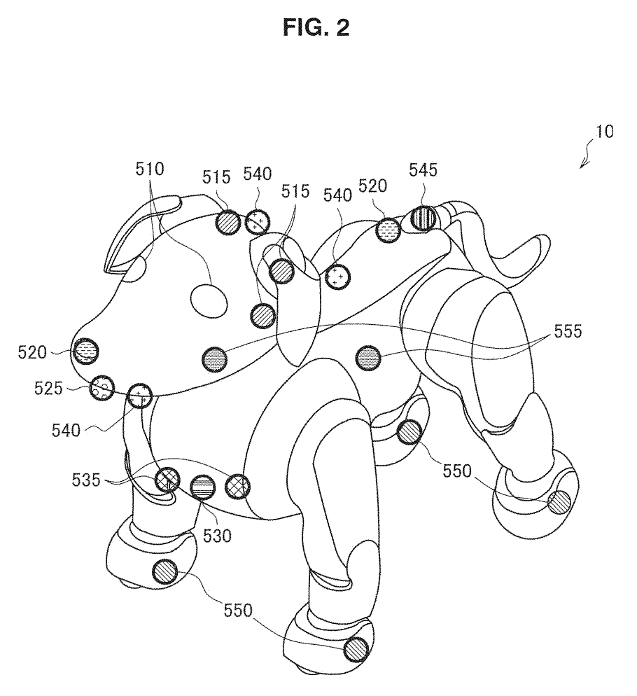

FIG. 2 is a diagram illustrating a hardware configuration example of the autonomous mobile object 10 according to an embodiment of the present disclosure. As illustrated in FIG. 2, the autonomous mobile object 10 is a quadrupedal robotic dog including a head, a trunk, four legs, and a tail. In addition, the autonomous mobile object 10 includes two displays 510 on the head.

In addition, the autonomous mobile object 10 includes various sensors. The autonomous mobile object 10 includes, for example, a microphone 515, a camera 520, a time of flight (ToF) sensor 525, a motion sensor 530, position sensitive detector (PSD) sensors 535, a touch sensor 540, an illuminance sensor 545, sole buttons 550, and inertia sensors 555.

(Microphone 515)

The microphone 515 has a function of picking up surrounding sound. Examples of the sound described above include user speech and surrounding environmental sound. The autonomous mobile object 10 may include, for example, four microphones on the head. Including the plurality of microphones 515 makes it possible to pick up sound generated in the surroundings with high sensitivity, and localize the sound source.

(Camera 520)

The camera 520 has a function of imaging a user and a surrounding environment. The autonomous mobile object 10 may include, for example, two wide-angle cameras on the tip of the nose and the waist. In this case, the wide-angle camera disposed on the tip of the nose captures the image corresponding to the forward field of vision (i.e., dog's field of vision) of the autonomous mobile object 10, and the wide-angle camera on the waist captures the image of the surrounding area around the upward direction. The autonomous mobile object 10 can extract a feature point or the like of the ceiling, for example, on the basis of the image captured by the wide-angle camera disposed on the waist, and achieve simultaneous localization and mapping (SLAM).

(ToF Sensor 525)

The ToF sensor 525 has a function of detecting the distance to an object present in front of the head. The ToF sensor 525 is provided to the tip of the head. The ToF sensor 525 allows the distance to various objects to be accurately detected, and makes it possible to achieve the operation corresponding to the relative positions with respect to targets, obstacles, and the like including a user.

(Motion Sensor 530)

The motion sensor 530 has a function of sensing the locations of a user, a pet kept by the user, and the like. The motion sensor 530 is disposed, for example, on the chest. The motion sensor 530 senses a moving object ahead, thereby making it possible to achieve various operations on the moving object, for example, the operations corresponding to emotions such as interest, fear, and surprise.

(PSD Sensors 535)

The PSD sensors 535 have functions of acquiring a situation of floor in front of the autonomous mobile object 10. The PSD sensors 535 are disposed, for example, at the chest. The PSD sensors 535 can detect the distance to an object present on the floor in front of the autonomous mobile object 10 with high accuracy, and achieve the operation corresponding to the relative position with respect to the object.

(Touch Sensor 540)

The touch sensor 540 has a function of sensing contact of a user. The touch sensor 540 is disposed, for example, in a place such as the top of the head, chin, and back where a user is likely to touch the autonomous mobile object 10. The touch sensor 540 may be, for example, an electrostatic capacity or pressure-sensitive touch sensor. The touch sensor 540 allows a contact act of a user such as touching, patting, beating, and pushing to be sensed, and makes it possible to perform the operation corresponding to the contact act.

(Illuminance Sensor 545)

The illuminance sensor 545 detects the illuminance of the space in which the autonomous mobile object 10 is positioned. The illuminance sensor 545 may be disposed, for example, at the base or the like of the tail behind the head. The illuminance sensor 545 detects the brightness of the surroundings, and makes it possible to execute the operation corresponding to the brightness.

(Sole Buttons 550)

The sole buttons 550 have functions of sensing whether or not the bottoms of the legs of the autonomous mobile object 10 are in contact with the floor. Therefore, the sole buttons 550 are disposed in the respective places corresponding to the paw pads of the four legs. The sole buttons 550 allow contact or non-contact of the autonomous mobile object 10 with the floor to be sensed, and make it possible to grasp, for example, that the autonomous mobile object 10 is lifted by a user or the like.

(Inertia Sensors 555)

The inertia sensors 555 are six-axis sensors that detect the physical quantity of the head or the trunk such as speed, acceleration, and rotation. That is, the inertia sensors 555 detect the acceleration and angular velocity of an X axis, a Y axis, and a Z axis. The respective inertia sensors 555 are disposed at the head and the trunk. The inertia sensors 555 detect the motion of the head and trunk of the autonomous mobile object 10 with high accuracy, and make it possible to achieve the operation control corresponding to a situation.

The above describes an example of a sensor included in the autonomous mobile object 10 according to an embodiment of the present disclosure. Note that the components described above with reference to FIG. 2 are merely examples. The configuration of a sensor that can be included in the autonomous mobile object 10 is not limited to that example. In addition to the components described above, the autonomous mobile object 10 may further include, for example, various communication apparatuses including a structured light camera, an ultrasonic sensor, a temperature sensor, a geomagnetic sensor and a global navigation satellite system (GNSS) signal receiver, and the like. The configuration of a sensor included in the autonomous mobile object 10 can be flexibly modified depending on the specifications and usage.

### <2.2. Functional Configuration Example of Autonomous Mobile Object>

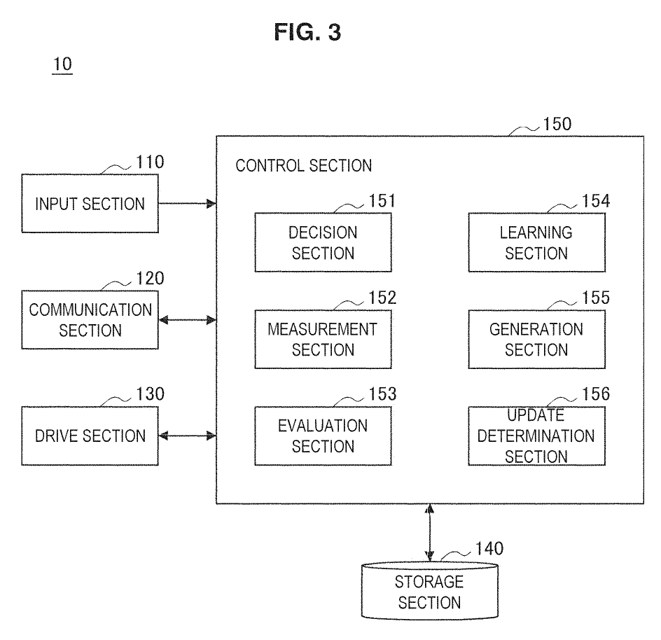

FIG. 3 is a block diagram illustrating a functional configuration example of the autonomous mobile object 10 according to the present embodiment. As illustrated in FIG. 3, the autonomous mobile object 10 includes an input section 110, a communication section 120, a drive section 130, a storage section 140, and a control section 150.

(Input Section 110)

The input section 110 has a function of collecting various kinds of information related to a surrounding environment of the autonomous mobile object 10. For example, the autonomous mobile object 10 collects image information related to a surrounding environment, and sensor information such as a user's uttered sound. Therefore, the input section 110 includes the various sensor apparatuses illustrated in FIG. 1. Besides, the input section 110 may collect sensor information from a sensor apparatus such as an environment installation sensor other than the sensor apparatuses included in the autonomous mobile object 10.

(Communication Section 120)

The communication section 120 has a function of transmitting and receiving information to and from another apparatus. The communication section 120 performs communication compliant with any wired/wireless communication standard such as a local area network (LAN), a wireless LAN, Wi-Fi (registered trademark), and Bluetooth (registered trademark). For example, the communication section 120 transmits and receives information to and from the user terminal 20.

(Drive Section 130)

The drive section 130 has a function of bending and stretching a plurality of joint sections of the autonomous mobile object 10 on the basis of the control of the control section 150. More specifically, the drive section 130 drives the actuator included in each joint section to achieve various actions of the autonomous mobile object 10 such as moving or rotating.

(Storage Section 140)

The storage section 140 has a function of temporarily or permanently storing information for the operation of the autonomous mobile object 10. For example, the storage section 140 stores sensor information collected by the input section 110 and a processing result of the control section 150. Moreover, the storage section 140 may store information indicating an action that has been taken or is to be taken by the autonomous mobile object 10. In addition, the storage section 140 may store information (e.g., position information and the like) indicating a state of the autonomous mobile object 10. The storage section 140 is implemented, for example, by a hard disk drive (HDD), a solid-state memory such as a flash memory, a memory card having a fixed memory installed therein, an optical disc, a magneto-optical disk, a hologram memory, or the like.

(Control Section 150)

The control section 150 has a function of controlling the overall operation of the autonomous mobile object 10. The control section 150 is implemented, for example, by an electronic circuit such as a central processing unit (CPU) or a microprocessor. The control section 150 may include a read only memory (ROM) that stores a program, an operation parameter and the like to be used, and a random access memory (RAM) that temporarily stores a parameter and the like varying as appropriate.

As illustrated in FIG. 3, the control section 150 includes a decision section 151, a measurement section 152, an evaluation section 153, a learning section 154, a generation section 155, and an update determination section 156.

The decision section 151 has a function of deciding an action of the autonomous mobile object 10. The decision section 151 uses the action model learned by the learning section 154 to decide an action. At that time, the decision section 151 can use a prediction result of the prediction model learned by the learning section 154 for an input into the action model. The decision section 151 outputs information indicating the decided action to the drive section 130 to achieve various actions of the autonomous mobile object 10 such as moving or rotating. A decision result of the decision section 151 may be stored in the storage section 140.

The measurement section 152 has a function of measuring a result obtained by the autonomous mobile object 10 taking the action decided by the decision section 151. The measurement section 152 stores a measurement result in the storage section 140 or outputs a measurement result to the evaluation section 153.

The evaluation section 153 has a function of evaluating, on the basis of the measurement result of the measurement section 152, the action easiness (i.e., movement easiness) of the environment in which the autonomous mobile object 10 takes an action. The evaluation section 153 causes the evaluation result to be stored in the storage section 140.

The learning section 154 has a function of controlling learning processing such as a prediction model and an action model used by the decision section 151. The learning section 154 outputs information (parameter of each model) indicating a learning result to the decision section 151.

The generation section 155 has a function of generating a UI screen for receiving a user operation regarding an action decision of the autonomous mobile object 10. The generation section 155 generates a UI screen on the basis of information stored in the storage section 140. On the basis of a user operation on this UI screen, for example, the information stored in the storage section 140 is changed.

The update determination section 156 determines whether to update a prediction model, an action model, and reference measurement information described below.

The above simply describes each component included in the control section. The detailed operation of each component will be described in detail below.

### <2.3. Functional Configuration Example of User Terminal>

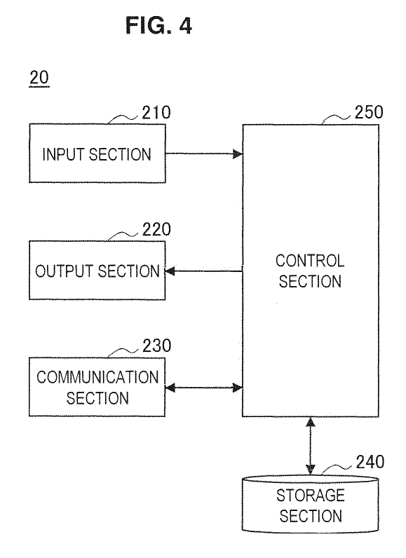

FIG. 4 is a block diagram illustrating a functional configuration example of the user terminal 20 according to the present embodiment. As illustrated in FIG. 4, the user terminal 20 includes an input section 210, an output section 220, a communication section 230, a storage section 240, and a control section 250.

(Input Section 210)

The input section 210 has a function of receiving the inputs of various kinds of information from a user. For example, the input section 210 receives the input of the setting regarding an action decision of the autonomous mobile object 10. The input section 210 is implemented by a touch panel, a button, a microphone, or the like.

(Output Section 220)

The output section 220 has a function of outputting various kinds of information to a user. For example, the output section 220 outputs various UI screens. The output section 220 is implemented, for example, by a display. Besides, the output section 220 may include a speaker, a vibration element, or the like.

(Communication Section 230)

The communication section 230 has a function of transmitting and receiving information to and from another apparatus. The communication section 230 performs communication compliant with any wired/wireless communication standard such as a local area network (LAN), a wireless LAN, Wi-Fi (registered trademark), and Bluetooth (registered trademark). For example, the communication section 230 transmits and receives information to and from the autonomous mobile object 10.

(Storage Section 240)

The storage section 240 has a function of temporarily or permanently storing information for the operation of the user terminal 20. For example, the storage section 240 stores setting about an action decision of the autonomous mobile object 10. The storage section 240 is implemented, for example, by an HDD, a solid-state memory such as a flash memory, a memory card having a fixed memory installed therein, an optical disc, a magneto-optical disk, a hologram memory, or the like.

(Control Section 250)

The control section 250 has a function of controlling the overall operation of the user terminal 20. The control section 250 is implemented, for example, by an electronic circuit such as a CPU or a microprocessor. The control section 150 may include a ROM that stores a program, an operation parameter and the like to be used, and a RAM that temporarily stores a parameter and the like varying as appropriate.

For example, the control section 250 receives a UI screen for receiving a setting operation regarding an action decision of the autonomous mobile object 10 from the autonomous mobile object 10 via the communication section 230, and causes the output section 220 to output the UI screen. In addition, the control section 250 receives information indicating a user operation on the UI screen from the input section 210, and transmits this information to the autonomous mobile object 10 via the communication section 230.

### 3. TECHNICAL FEATURES

### <3.1. Acquisition of Measurement Information>

The measurement section 152 measures an action result (which will also be referred to as measurement information below) of the autonomous mobile object 10. The measurement information is information that is based on at least any of moving distance, moving speed, the amount of consumed power, a motion vector (vector based on the position and orientation before movement) including position information (coordinates) before and after movement, a rotation angle, angular velocity, vibration, or inclination. Note that the rotation angle may be the rotation angle of the autonomous mobile object 10, or the rotation angle of a wheel included in the autonomous mobile object 10. The same applies to the angular velocity. The vibration is the vibration of the autonomous mobile object 10 to be measured while moving. The inclination is the attitude of the autonomous mobile object 10 after movement which is based on the attitude before movement. The measurement information may include these kinds of information themselves. In addition, the measurement information may include a result obtained by applying various operations to these kinds of information. For example, the measurement information may include the statistic such as the average or median of values measured a plurality of times.

The measurement section 152 measures an action result when the autonomous mobile object 10 takes a predetermined action (which will also be referred to as measurement action below), thereby acquiring measurement information. The measurement action may be moving straight such as moving for a predetermined time, moving for predetermined distance, walking a predetermined number of steps, or rotating both right and left wheels a predetermined number of times. In addition, the measurement action may be a rotary action such as rotating for a predetermined time, rotating for a predetermined number of steps, or inversely rotating both right and left wheels a predetermined number of times.

In the case where the measurement action is moving straight, the measurement information can include at least any of moving distance, moving speed, the amount of consumed power, a rotation angle, angular velocity, an index indicating how straight the movement is, or the like. In the case where the measurement action is a rotary action, the measurement information can include at least any of a rotation angle, angular velocity, the amount of consumed power, or a positional displacement (displacement of the position before and after one rotation). The measurement section 152 acquires the measurement information for each type of measurement action.

The measurement section 152 acquires, as reference measurement information (corresponding to the second measurement information), measurement information when the autonomous mobile object 10 takes a measurement action in a reference environment (corresponding to the second environment). The reference environment is an environment that is a reference for evaluating action easiness. It is desirable that the reference environment be an environment such as the floor of a factory, a laboratory, or a user's house that has no obstacle, is not slippery, and facilitates movement. The reference measurement information can be acquired at the time of factory shipment, the timing at which the autonomous mobile object 10 is installed in the house for the first time, or the like.

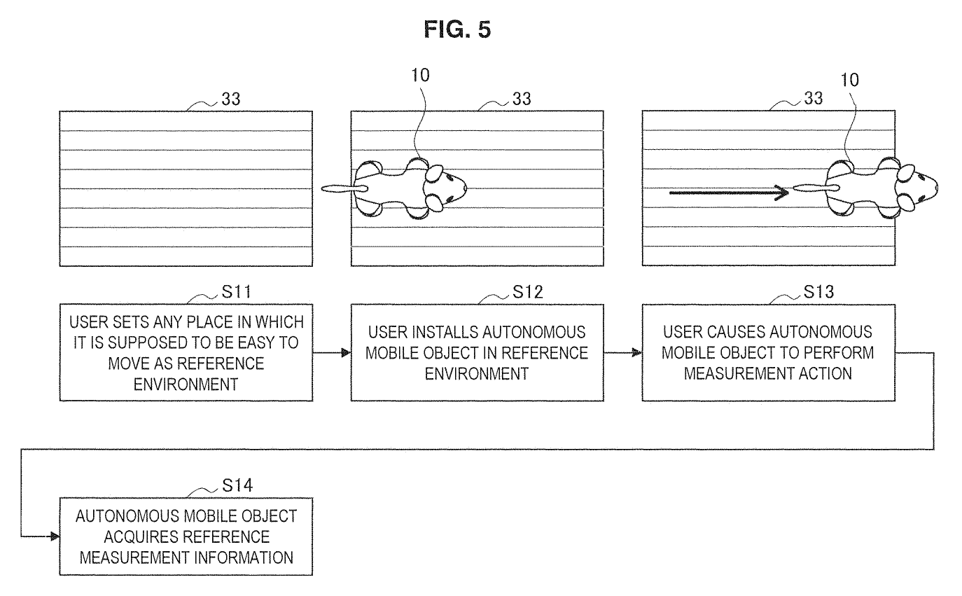

The acquisition of the reference measurement information will be described with reference to FIG. 5. FIG. 5 is a diagram for describing an acquisition example of the reference measurement information according to the present embodiment. As illustrated in FIG. 5, first, a user sets any place in which it is supposed to be easy to move as a reference environment (step S11). It is assumed here that the area on the wooden floor 33 is set as a reference environment. Then, the user installs the autonomous mobile object 10 on the wooden floor 33 serving as a reference environment (step S12). Next, the user causes the autonomous mobile object 10 to perform a measurement action (step S13). In the example illustrated in FIG. 5, the measurement action is moving straight. The autonomous mobile object 10 then acquires reference measurement information (step S14).

In addition, the measurement section 152 acquires measurement information (corresponding to the first measurement information) when the autonomous mobile object 10 takes a measurement action in an action environment (corresponding to the first environment). The action environment is an environment in which the autonomous mobile object 10 actually takes an action (e.g., grounded), and the area on a wooden floor or a carpet of the user's house. In the case where the autonomous mobile object 10 takes an action in the reference environment, the action environment is synonymous with the reference environment. The measurement information can be acquired at any timing such as the timing at which an environment for which measurement information has not yet been acquired is found.

Note that the measurement action does not have to be a dedicated action for measurement. For example, the measurement action may be included in a normal operation. In this case, when the autonomous mobile object 10 performs a normal operation in the action environment, measurement information is automatically collected.

The storage section 140 stores reference measurement information. The stored reference measurement information is used to calculate an evaluation value described below. Meanwhile, the measurement section 152 outputs the measurement information acquired in the action environment to the evaluation section 153.

### <3.2. Actual Measurement of Evaluation Value>

The evaluation section 153 calculates an evaluation value (corresponding to the action cost information) indicating the action easiness (i.e., movement easiness) of an environment in which the autonomous mobile object 10 takes an action. The evaluation value is calculated by comparing reference measurement information measured for the autonomous mobile object 10 when the autonomous mobile object 10 takes an action in a reference environment with measurement information measured for the autonomous mobile object 10 when the autonomous mobile object 10 takes an action in an action environment. A comparison between results of the actions is used to calculate an evaluation value, so that it is possible to calculate an evaluation value for any action method (walking/running). As an example, it is assumed that the evaluation value is a real number value from 0 to 1. A higher value means higher action easiness (i.e., it is easier to move), and a lower value means lower action easiness (i.e., it is more difficult to move). Needless to say, the range of evaluation values is not limited to a range of 0 to 1. A lower value may mean lower action easiness, and a higher value may mean higher action easiness.

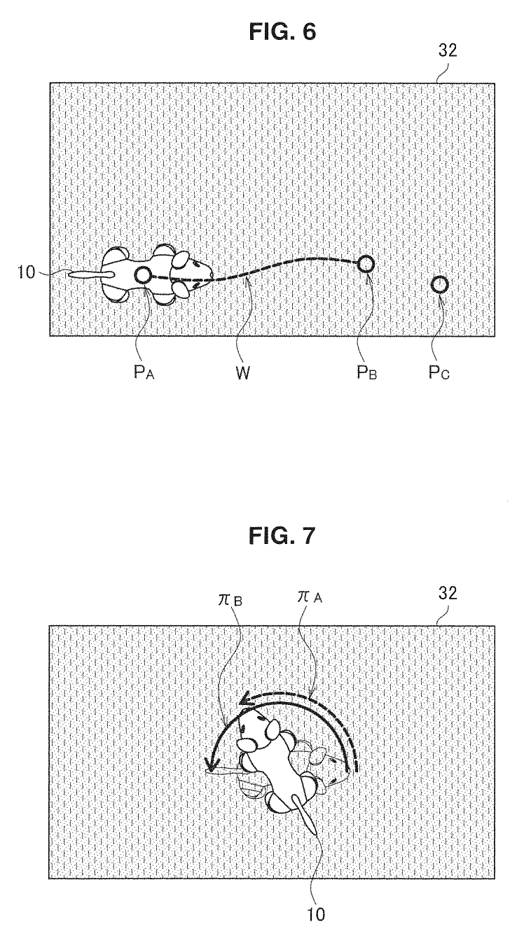

A calculation example of an evaluation value in the case where a measurement action is moving straight will be described with reference to FIG. 6. FIG. 6 is a diagram for describing a calculation example of an evaluation value according to the present embodiment. As illustrated in FIG. 6, an action environment is the area on the carpet 32, and it is assumed that the autonomous mobile object 10 starts to move straight from a position P_{A} for a predetermined time, and arrives at a position P_{B} via a movement trajectory W. In addition, according to reference measurement information, it is assumed that, if an action environment is a reference environment, the start of the straight movement from the position P_{A} for a predetermined time brings the autonomous mobile object 10 to a position P_{C}. The evaluation value may be the difference or ratio between moving distance |P_{A}P_{C}| in the reference environment and moving distance |P_{A}P_{B}| in the action environment. The evaluation value may also be the difference or ratio between the speed in the reference environment and the speed in the action environment. The evaluation value may also be the difference or ratio between the amount of consumed power in the reference environment and the amount of consumed power in the action environment. The evaluation value may also be the difference or ratio between the rotation angle in the reference environment and the rotation angle in the action environment. The evaluation value may also be the difference or ratio between the angular velocity in the reference environment and the angular velocity in the action environment. The evaluation value may also be an index (e.g., 1.0−|P_{D}P_{B}|/|P_{A}P_{C}|) indicating how straight the movement is and how long the movement is. The evaluation value may also be the similarity or angle between a vector P_{A}P_{C} and a vector P_{A}P_{B}.

A calculation example of an evaluation value in the case where a measurement action is a rotary action will be described with reference to FIG. 7. FIG. 7 is a diagram for describing a calculation example of an evaluation value according to the present embodiment. As illustrated in FIG. 7, an action environment is the area on the carpet 32, and it is assumed that the autonomous mobile object 10 takes a rotary action for a predetermined time, and the rotation angle is π_{A}. In addition, according to reference measurement information, it is assumed that, if an action environment is a reference environment, the rotary action of the autonomous mobile object 10 for a predetermined time results in a rotation angle of π_{B}. The evaluation value may also be the difference or ratio between the rotation angle π_{A} in the reference environment and the rotation angle π_{B} in the action environment. The evaluation value may also be the difference or ratio between the angular velocity in the reference environment and the angular velocity in the action environment. The evaluation value may also be the difference or ratio between the amount of consumed power in the reference environment and the amount of consumed power in the action environment. The evaluation value may also be the difference or ratio between a positional displacement (displacement of a position before and after a predetermined number of rotations (e.g., one rotation)) in the reference environment and a positional displacement in the action environment.

The evaluation value is acquired by any of the calculation methods described above. The evaluation value may also be acquired as one value obtained by combining a plurality of values calculated by the plurality of calculation methods described above. In addition, the evaluation value may also be acquired as a value including a plurality of values calculated by the plurality of calculation methods described above. In addition, any linear transformation or non-linear transformation may be applied to the evaluation value.

The evaluation section 153 calculates an evaluation value whenever the autonomous mobile object 10 performs a measurement action. The evaluation value is stored in association with the type of measurement action, measurement information, and information (environment information described below) indicating an environment when the measurement information is acquired. The evaluation value may be stored further in association with position information when the measurement information is acquired. For example, in the case where the position information is used for display on an UI screen, a determination about whether to update a prediction model and an action model, or inputs into the prediction model and the action model, it is desirable to store the position information in association with the evaluation value.

### <3.3. Prediction of Evaluation Value>

The learning section 154 learns a prediction model that predicts an evaluation value from environment information of an action environment. The evaluation value is predicted by inputting the environment information of the action environment into the prediction model. This allows the autonomous mobile object 10 to predict the evaluation value of even an unevaluated environment for which an evaluation value has not yet been actually measured. That is, there are two types of evaluation values: an actually measured value that is actually measured via a measurement action performed in the action environment; and a prediction value that is predicted by the prediction model.

The environment information is information indicating an action environment. The environment information may be sensor information subjected to sensing by the autonomous mobile object 10, or may be generated on the basis of sensor information. For example, the environment information may be a captured image obtained by imaging an action environment, a result obtained by applying processing such as patching to the captured image, or a feature amount such as a statistic. The environment information may include position information, action information (including the type of action such as moving straight or rotating, an action time, and the like), or the like except for sensor information.

Specifically, the environment information includes sensor information related to an environment in the moving direction (typically, the front direction of the autonomous mobile object 10). The environment information can include a captured image obtained by imaging the area in the moving direction, depth information of the moving direction, the position of an object present in the moving direction, information indicating the action easiness of an action taken on the object, and the like. As an example, the following assumes that the environment information is a captured image obtained by imaging the area in the moving direction of the autonomous mobile object 10.

A prediction model may output the evaluation value of a real number value with no change. In addition, the prediction model may output a result obtained by quantifying and classifying the evaluation value of a real number value into N stages. The prediction model may output the vector of the evaluation value.

In the case where environment information to be input is an image, the prediction model may output the evaluation value of each pixel. In that case, for example, the same evaluation values are imparted to all the pixels as labels, and learning is performed. Besides, like the case where segmentation (floor detection is also an example of segmentation) described below is combined with prediction, a label different for each segment is imparted, and learning is performed in some cases. For example, a label is imparted to only the largest segment or a specific segment in the image, special labels indicating the other areas are not used for learning are imparted, and then learning is performed in some cases.

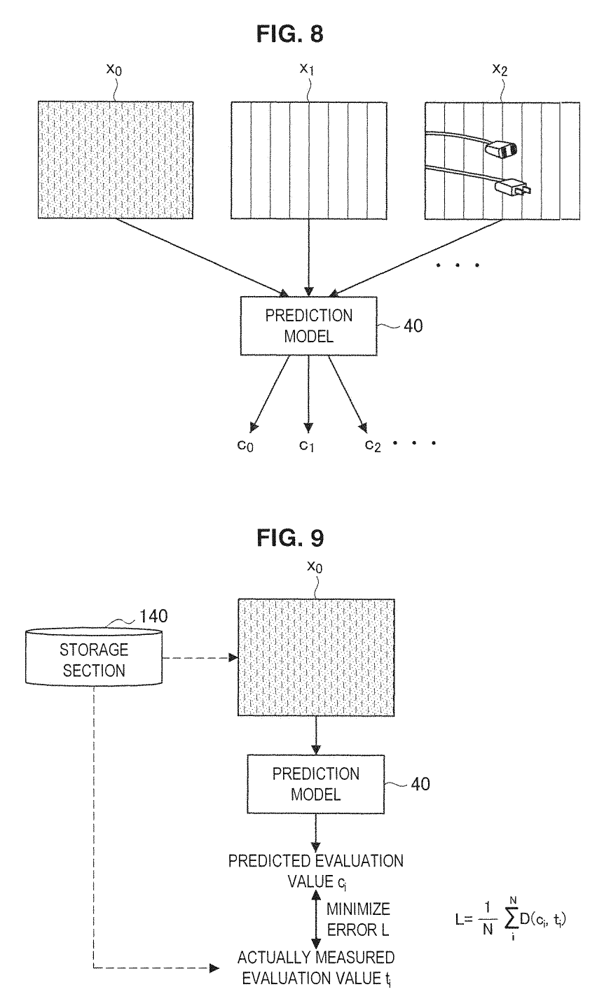

FIG. 8 is a diagram for describing an example of a prediction model according to the present embodiment. As illustrated in FIG. 8, once the prediction model 40 receives environment information x₀, an evaluation value co is output. Similarly, once the prediction model 40 receives environment information x₁, an evaluation value c₁ is output. Once the prediction model 40 receives environment information x₂, an evaluation value c₂ is output.

FIG. 9 is a diagram for describing a learning example of a prediction model according to the present embodiment. It is assumed that the autonomous mobile object 10 performs a measurement action in an environment in which the environment information x₀ is acquired, and measurement information is acquired. The environment information x₀ and the measurement information are temporarily stored in the storage section 140. In addition, an evaluation value tᵢ calculated (i.e., actually measured) by the evaluation section 153 is also stored in the storage section 140. Meanwhile, the learning section 154 acquires the environment information x₀ from the storage section 140, and inputs the environment information x₀ into the prediction model 40 to predict an evaluation value cᵢ. Then, the learning section 154 learns a prediction model to minimize the error (which will also be referred to as prediction error below) between the evaluation value tᵢ obtained from measurement (i.e., actually measured) and the evaluation value cᵢ obtained from a prediction according to the prediction model. That is, the learning section 154 learns a prediction model to minimize a prediction error L shown in the following formula. Note that i represents an index of environment information.

$$L = \frac{1}{N} {\sum }_{i}^{N} D ( {c}_{i} , {t}_{i} ) \qquad ( 1 )$$

D may be a function for calculating a square error or the absolute value of an error with respect to the problem that an evaluation value t is regressed. In addition, D may be a function for calculating a cross entropy with respect to the problem that the evaluation value t is quantified and classified. Besides, as D, any error function usable for the regression or the classification can be used.

A prediction model can be constructed with any model. For example, the prediction model can be constructed with a neural network, linear regression, logistic regression, a decision tree, a support vector machine, fitting to any distribution such as normal distribution, or a combination thereof. Moreover, the prediction model may also be constructed as a model that shares a parameter with an action model described below.

Besides, the prediction model may be a model that maps an evaluation value to an environment map (e.g., floor plan of a user's house in which the autonomous mobile object 10 is installed) showing the action range of the autonomous mobile object 10 for retainment. In this case, learning means accumulating evaluation values mapped to the environment map. If position information is input into the prediction model and an evaluation value is actually measured and retained at a position indicated by the input position information, the evaluation value is output. In contrast, if no evaluation value is actually measured at a position indicated by the input position information, filtering processing such as smoothing is applied to an evaluation value that has been actually measured in the vicinity and the evaluation value is output.

Floor detection may be combined with prediction. For example, environment information includes a captured image obtained by imaging an action environment. An evaluation value is predicted for only an area such as a floor in the captured image on which the autonomous mobile object 10 is capable of taking an action. With respect to learning, an evaluation value can be imparted, as a label, to only an area such as a floor on which the autonomous mobile object 10 is capable of taking an action, and constants such as 0 can be imparted to the other areas to perform learning.

Segmentation may be combined with prediction. For example, environment information includes a captured image obtained by imaging an action environment. An evaluation value is predicted for each segmented partial area of the captured image. With respect to learning, the captured image can be segmented for each of areas different in action easiness, and an evaluation value can be imparted to each segment as a label to perform learning.

### <3.4. Decision of Action>

The decision section 151 decides an action of the autonomous mobile object 10 in an action environment on the basis of environment information and an action model. For example, the decision section 151 inputs the environment information of the action environment into the action model to decide an action of the autonomous mobile object 10 in the action environment. At that time, the decision section 151 may input an evaluation value into the action model, or does not have to input an evaluation value into the action model. For example, in reinforcement learning described below in which an evaluation value is used as a reward, an evaluation value does not have to be input into the action model.

Specifically, in an action environment for which an evaluation value has not yet been evaluated, the decision section 151 predicts, on the basis of the environment information, an evaluation value indicating a cost when the autonomous mobile object 10 takes an action in the action environment. For such a prediction, a prediction model learned by the learning section 154 is used. Then, the decision section 151 decides an action of the autonomous mobile object 10 in the action environment on the basis of the evaluation value predicted for the action environment. This makes it possible to decide an appropriate action according to whether the evaluation value is high or low even in the action environment for which an evaluation value has not yet been evaluated. Meanwhile, the decision section 151 acquires an evaluation value stored in the storage section 140 in an action environment for which an evaluation value has been actually measured, and decides an action of the autonomous mobile object 10 in the action environment on the basis of the evaluation value. This makes it possible to decide, in the action environment for which an evaluation value has been actually measured, an appropriate action in accordance with whether the actually measured evaluation value is high or low even. Needless to say, the decision section 151 may predict an evaluation value even in the action environment for which an evaluation value has been actually measured similarly to an action environment for which an evaluation value has not yet been evaluated, and decide an action of the autonomous mobile object 10 in the action environment on the basis of the predicted evaluation value. Therefore, an evaluation value and position information do not have to be stored in association with each other.

The decision section 151 decides at least any of parameters related to movement such as the movability, a moving direction, moving speed, the amount of movement, a movement time, and the like of the autonomous mobile object 10. The decision section 151 may decide parameters regarding rotation such as a rotation angle and angular velocity. In addition, the decision section 151 may decide discrete parameters such as proceeding for n steps and rotating at k degrees, or decide a control signal having a continuous value for controlling an actuator.

An action model can be constructed with any model. For example, the action model is constructed with a neural network such as a convolutional neural network (CNN) or a recurrent neural network (RNN). Besides, the action model may also be constructed with a set of if-then rules. The action model may also be a model that partially shares a parameter (weight of the neural network) with a prediction model.

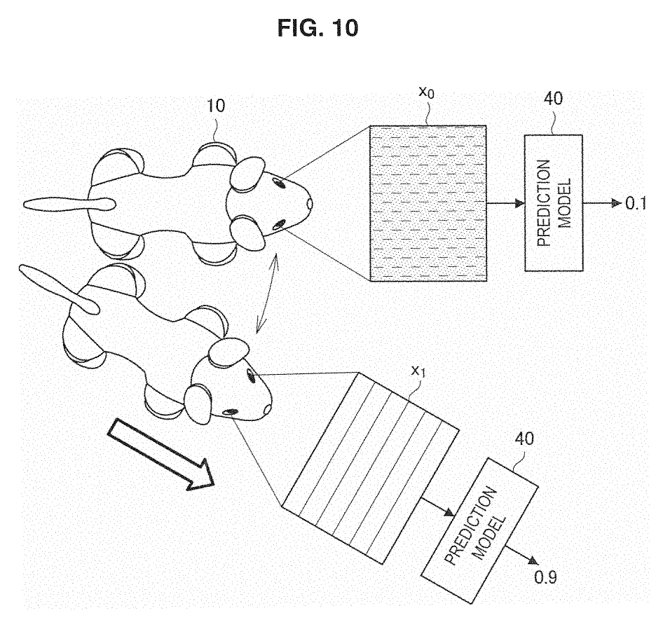

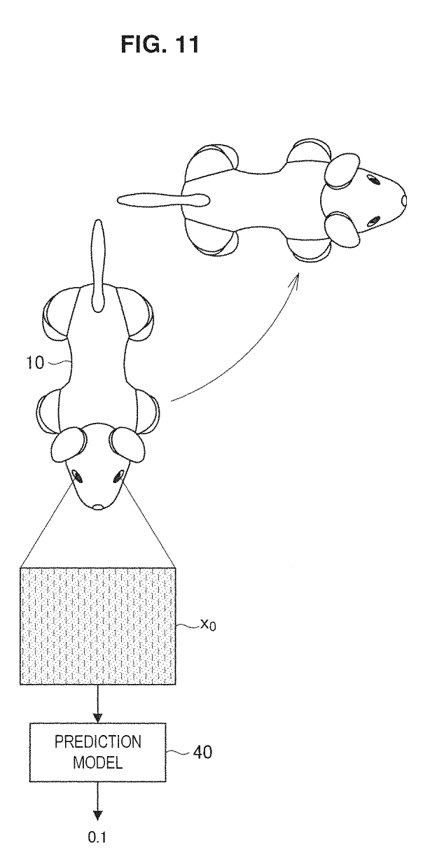

With reference to FIGS. 10 and 11, the following describes an action decision example in which an action model is a set of if-then rules.

FIG. 10 is a diagram for describing an action decision example of the autonomous mobile object 10 according to the present embodiment. As illustrated in FIG. 10, it is assumed that the autonomous mobile object 10 images the area in the front direction while rotating on the spot, thereby acquiring the plurality of pieces of environment information x₀ and x₁. The decision section 151 inputs the environment information x₀ into the prediction model 40 to acquire 0.1 as the prediction value of an evaluation value. In addition, the decision section 151 inputs the environment information x₁ into the prediction model 40 to acquire 0.9 as the prediction value of an evaluation value. Since the environment information x₁ has a higher evaluation value and higher action easiness, the decision section 151 decides movement in the direction in which the environment information x₁ is acquired. In this way, in the case where there are a plurality of options as the moving direction, the decision section 151 decides movement in the moving direction having the highest action easiness. This allows the autonomous mobile object 10 to select the environment in which it is the easiest to taken an action move, and suppresses power consumption.

FIG. 11 is a diagram for describing an action decision example of the autonomous mobile object 10 according to the present embodiment. As illustrated in FIG. 11, it is assumed that the autonomous mobile object 10 images the area in the current front direction, thereby acquiring the environment information x₀. The decision section 151 inputs the environment information x₀ into the prediction model 40 to acquire 0.1 as an evaluation value. In this case, the decision section 151 decides that no movement is made because the prediction value of the evaluation value is low, that is, the action easiness is low. Moreover, the decision section 151 may decide another action such as rotation illustrated in FIG. 11.

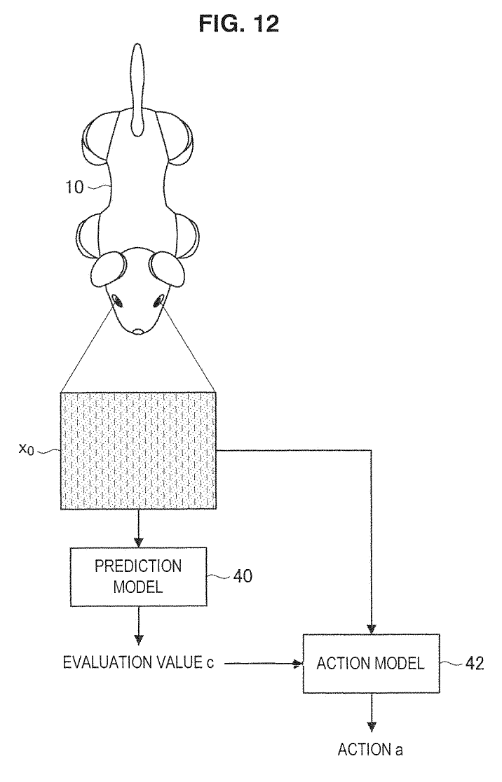

With reference to FIG. 12, the following describes an action decision example in which an action model is a neural network.

FIG. 12 is a diagram for describing an action decision example of the autonomous mobile object 10 according to the present embodiment. As illustrated in FIG. 12, it is assumed that the autonomous mobile object 10 images the area in the current front direction, thereby acquiring the environment information x₀. The decision section 151 inputs the environment information x₀ into the prediction model 40 to acquire an evaluation value c as an evaluation value. The decision section 151 inputs the environment information x₀ and the evaluation value c into the action model 42 to acquire an action a. The decision section 151 decides the action a as an action in the action environment in which the environment information x₀ is acquired.

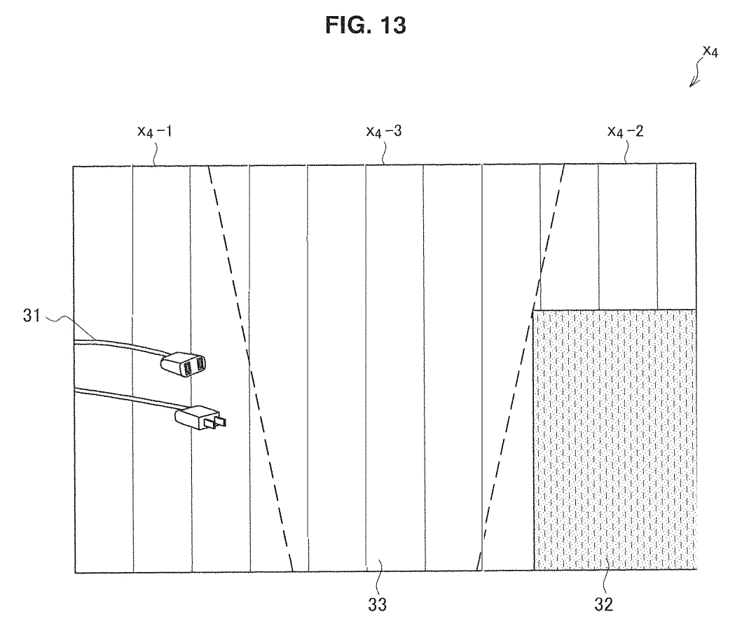

Segmentation may be combined with prediction. In that case, an action is decided on the basis of a prediction of the evaluation value for each segment. This point will be described with reference to FIG. 13.

FIG. 13 is a diagram for describing a prediction example of an evaluation value by the autonomous mobile object 10 according to the present embodiment. It is assumed that a captured image x₄ illustrated in FIG. 13 is acquired as environment information. For example, the decision section 151 segments the captured image x₄ into a partial area x₄-1 in which the cable 31 is placed, a partial area x₄-2 with the carpet 32, and a partial area x₄-3 with nothing but the wooden floor 33. Then, the decision section 151 inputs an image of each partial area into the prediction model to predict the evaluation value for each partial area. In this case, the evaluation value of the partial area x₄-3 is higher than the evaluation values of other areas in which it is difficult to move, so that movement in the direction of the partial area x₄-3 is decided. This allows the autonomous mobile object 10 to appropriately select a moving direction even without acquiring a plurality of pieces of environment information or the like while rotating on the spot as described with reference to FIG. 10. Note that, in the case where a prediction model is learned that predicts an evaluation value for each pixel, the decision section 151 may input the entire captured image x₄ into the prediction model to predict an evaluation value for each pixel. In that case, the decision section 151 may convert, for example, an evaluation value for each pixel into an evaluation value for each partial area (e.g., perform statistical processing such as taking an average for each partial area), and use it to decide an action.

### <3.5. Learning of Action Model>

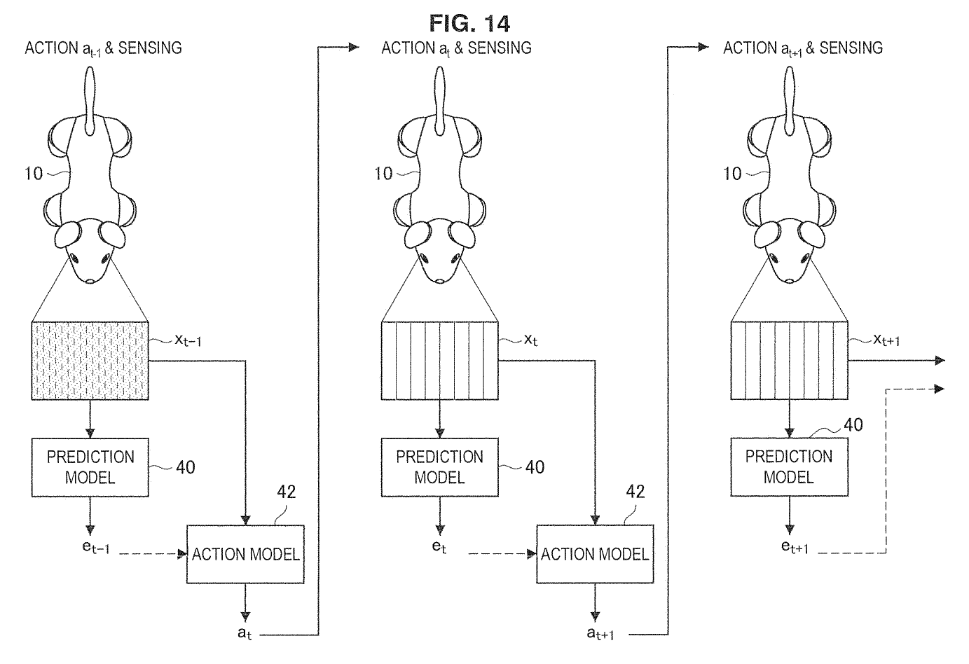

The learning section 154 learns an action model for deciding an action of the autonomous mobile object 10 on the basis of environment information of an action environment, and an evaluation value indicating a cost when the autonomous mobile object 10 takes an action in the action environment. The action model and the prediction model may be concurrently learned, or separately learned. The learning section 154 may use reinforcement learning in which an evaluation value is used as a reward to learn the action model. This point will be described with reference to FIG. 14.

FIG. 14 is a diagram for describing a learning example of an action model by the autonomous mobile object 10 according to the present embodiment. As illustrated in FIG. 14, at time t, the autonomous mobile object 10 performs an action aₜ decided at time t−1 and sensing to acquire environment information xₜ. The decision section 151 inputs the environment information xₜ into the prediction model 40 to acquire an evaluation value eₜ, and inputs the environment information xₜ and the evaluation value eₜ into the action model 42 to decide an action aₜ₊₁ at next time t+1. At this time, the decision section 151 uses the evaluation value eₜ at the time t as a reward, and uses reinforcement learning to learn the action model 42. The decision section 151 may use not only the evaluation value eₜ, but also another reward together to perform reinforcement learning. The autonomous mobile object 10 repeats such a series of processing. Note that the evaluation value does not have to be used for an input into the action model 42.

The autonomous mobile object 10 can have a plurality of action modes. Examples of an action mode include a high-speed movement mode for high speed movement, a low-speed movement mode for low speed movement, a low-sound movement mode for miniaturizing moving sound, and the like. The learning section 154 performs learning for each action mode of the autonomous mobile object 10. For example, the learning section 154 learns a prediction model and an action model for each action mode. Then, the decision section 151 uses the prediction model and action model corresponding to an action mode to decide an action of the autonomous mobile object 10. This allows the autonomous mobile object 10 to decide an appropriate action for each action mode.

### <3.6. Reflection of Request of User>

An actually measured evaluation value influences the learning of a prediction model, and also influences a decision of an action. For example, it is easier for the autonomous mobile object 10 to move to a position of a high evaluation value, and it is more difficult to move to a position of a low evaluation value. However, a user can wish to move to even a position of low action easiness. Conversely, a user can wish to refrain from moving to a position of high action easiness. It is desirable to reflect such requests of a user in an action of the autonomous mobile object 10.

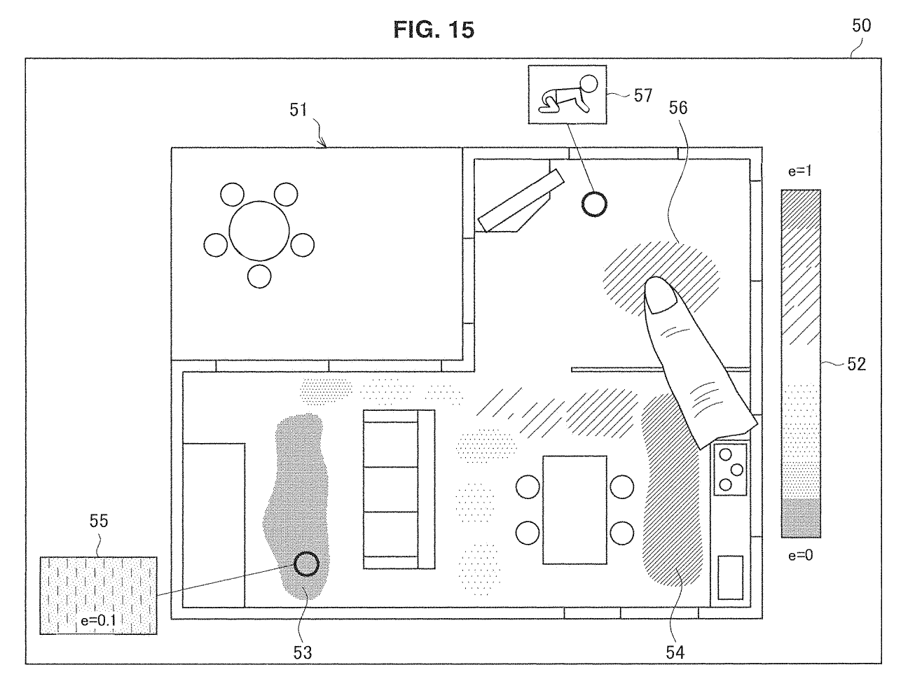

Then, the generation section 155 generates a UI screen (display image) for receiving a setting operation regarding an action decision of the autonomous mobile object 10. Specifically, the generation section 155 generates a UI screen associated with an evaluation value for each position on an environment map showing the action range of the autonomous mobile object 10. The action range of the autonomous mobile object 10 is a range within which the autonomous mobile object 10 can take an action. The generated UI image is displayed, for example, by the user terminal 20, and receives a user operation such as changing an evaluation value. The decision section 151 decides an action of the autonomous mobile object 10 in the action environment on the basis of the evaluation value input according to a user operation on a UI image. This makes it possible to reflect a request of a user in an action of the autonomous mobile object 10. Such a UI screen will be described with reference to FIG. 15.

FIG. 15 is a diagram illustrating an example of a UI screen displayed by the user terminal 20 according to the present embodiment. A UI screen 50 illustrated in FIG. 15 shows that information indicating an evaluation value actually measured at each position in a floor plan of a user's house in which the autonomous mobile object 10 is installed is superimposed and displayed on the position. The information indicating an evaluation value is expressed, for example, with color, the rise and fall of luminance, or the like. In the example illustrated in FIG. 15, as shown in a legend 52, the information indicating an evaluation value is expressed with types and density of hatching. An area 53 has a low evaluation value (i.e., low action easiness), and an area 54 has a high evaluation value (i.e., high action easiness).

A user can correct an evaluation value with a UI like a paint tool. In the example illustrated in FIG. 15, a user inputs a high evaluation value into an area 56. The input evaluation value is stored in the storage section 140 in association with position information of the area 56. Then, the autonomous mobile object 10 decides an action by assuming that the evaluation value of the position corresponding to the area 56 is high. Accordingly, it is easier to move to the position of the area 56. In this way, a user becomes able to control the tendency of movement of the autonomous mobile object 10 by inputting a high evaluation value into a course movement to which is recommended, and conversely inputting a low evaluation value into an area that permits no entry.

In the UI screen 50, environment information may be displayed in association with the position at which the environment information is acquired. For example, the environment information 55 is displayed in association with the position at which the environment information 55 is acquired, and it is also shown that the position has an evaluation value of 0.1. In addition, environment information 57 is displayed in association with the position at which the environment information 57 is acquired. The environment information 57 is a captured image including a child. On the basis of the displayed environment information 57, a user can input a high evaluation value into an area having a child such that it is easier for the autonomous mobile object 10 to move to the area having the child. This allows, for example, the autonomous mobile object 10 to take a large number of photographs of the child.

In the UI screen 50, an evaluation value may be displayed for each action mode of the autonomous mobile object 10.

Note that a calculation method for an evaluation value may also be customizable on the UI screen 50.

### <3.7. Update Trigger>

The autonomous mobile object 10 (e.g., update determination section 156) determines whether or not it is necessary to update reference measurement information and/or a prediction model.

For example, at the time when an environment is changed, a prediction model is updated. The time when an environment is changed is the time when the autonomous mobile object 10 is installed in a new room, the time when a carpet is changed, the time when an obstacle is placed, or the like. In this case, the prediction error of an evaluation value can be large in an unknown environment (place in which a carpet is newly placed). Meanwhile, the prediction error of an evaluation value remains small in a known environment (place for which an evaluation value has been actually measured). In this case, a prediction model alone has to be updated.

For example, when the behavior of the autonomous mobile object 10 is changed, reference measurement information and a prediction model are updated. This is because, once the behavior of the autonomous mobile object 10 is changed, the prediction error of an evaluation value can be large in not only an unknown environment, but also a known environment. The behavior of the autonomous mobile object 10 is an actual action (driven by the drive section 130) of the autonomous mobile object 10. When the relationship between an action decided by the decision section 151 and an actual action achieved by the driving of an actuator is changed, reference measurement information and a prediction model are updated. The behavior of the autonomous mobile object 10 is changed, for example, by the deterioration of the autonomous mobile object 10 over time, version upgrading, or updating a primitive operation according to learning, or the like. Note that the primitive operation is directly relevant to a measurement action such as moving straight (walking) and making a turn.

The measurement section 152 measures reference measurement information again in the case where the update determination section 156 determines that the reference measurement information has to be updated. For example, the update determination section 156 causes the autonomous mobile object 10 or the user terminal 20 to visually or aurally output information that instructs a user to install the autonomous mobile object 10 in a reference environment. Once the autonomous mobile object 10 is installed in the reference environment afterward, the measurement section 152 measures the reference measurement information. Then, the storage section 140 stores the newly measured reference measurement information.

In the case where the update determination section 156 determines that the prediction model has to be updated, the learning section 154 updates the prediction model. For example, the learning section 154 temporarily discards learning data used before updating, and newly accumulates learning data for learning.

The following describes a determination example of an update target in detail.

Example in which User Interaction is Used

The update determination section 156 controls whether or not a prediction model is updated on the basis of the error (i.e., prediction error) between an evaluation value obtained from measurement and an evaluation value obtained from a prediction according to the prediction model. Specifically, the update determination section 156 calculates prediction errors in various action environments, and causes the storage section 140 to store the prediction errors. Then, the update determination section 156 calculates the statistic such as the average, median, maximum value, or minimum value of a plurality of prediction errors accumulated in the storage section 140, and makes a comparison or the like between the calculated statistic and a threshold to determine whether or not the prediction model has to be updated. For example, in the case where the statistic is larger than the threshold, the update determination section 156 determines that the prediction model is updated. In the case where the statistic is smaller than the threshold, the update determination section 156 determines that the prediction model is not updated.

On the basis of the error between the reference measurement information used to calculate an evaluation value and the newly measured measurement information (corresponding to the third measurement information) in the reference environment, the update determination section 156 determines whether or not the reference measurement information used to calculate an evaluation value is updated. In the case where it is determined that the prediction model is updated, the update determination section 156 may determine whether or not the reference measurement information is updated. Specifically, in the case where it is determined that the prediction model should be updated, the update determination section 156 causes the autonomous mobile object 10 or the user terminal 20 to visually or aurally output information that instructs a user to install the autonomous mobile object 10 in a reference environment. Once the autonomous mobile object 10 is installed in the reference environment, the measurement section 152 measures the measurement information in the reference environment. Then, the update determination section 156 calculates the error between the reference measurement information used to calculate an evaluation value and the newly measured measurement information, and determines on the basis of the error whether or not it is necessary to update. For example, in the case where the error is larger than the threshold, the update determination section 156 determines that the reference measurement information is replaced with the newly measured measurement information in the reference environment. In this case, the prediction model and the reference measurement information are both updated. In contrast, in the case where the error is smaller than threshold, the update determination section 156 determines that the reference measurement information is not updated. In this case, only a prediction model is updated.

Example in which Additional Information is Used

A determination about whether or not it is necessary to update a prediction model is similar to that of the example in which a user interaction is used.

In a known environment, the update determination section 156 determines whether or not the reference measurement information is updated, on the basis of the error (i.e., prediction error) between an evaluation value obtained from measurement and an evaluation value obtained from a prediction according to a prediction model. For example, in the case where the prediction error is larger than threshold, the update determination section 156 determines that the reference measurement information is updated. In this case, the prediction model and the reference measurement information are both updated. In contrast, in the case where the prediction error is smaller than threshold, the update determination section 156 determines that the reference measurement information is not updated. In this case, only a prediction model is updated. Note that the prediction error calculated to determine whether or not it is necessary to update the prediction model may be used as a prediction error on which the determination is based, or a prediction error may be newly calculated in the case where it is determined that the prediction model is updated.

Here, the known action environment is an action environment for which an evaluation value has already been measured. Position information of a reference environment or an action environment for which an evaluation value used to learn a prediction model is calculated may be stored, and it may be determined on the basis of the stored position information whether or not it is a known action environment. In addition, environment information of a reference environment or environment information of an action environment used to learn a prediction model may be stored, and it may be determined on the basis of the similarity to the stored environment information whether or not it is a known action environment.

Note that, in the case where it is difficult to determine whether the known environment is an unknown environment, the update determination section 156 may determine that the reference measurement information is updated whenever it is determined to update the prediction model.

The action model can also be updated according to learning. However, even if the action model is updated, the reference measurement information or the prediction model does not have to be necessarily updated. For example, in the case where an action policy or schedule (relatively sophisticated action) alone is changed by updating the action model, the reference measurement information and the prediction model do not have to be updated. Meanwhile, when the behavior of the autonomous mobile object 10 is changed, it is desirable that an action model, reference measurement information and a prediction model be all updated. At that time, the action model, the reference measurement information, and the prediction model may be updated at one time, or updated alternatively. For example, updating may be repeated until convergence. In the case where the autonomous mobile object 10 stores the place of the reference environment, it is possible to automatically repeat updating these.

### <3.8. Flow of Processing>

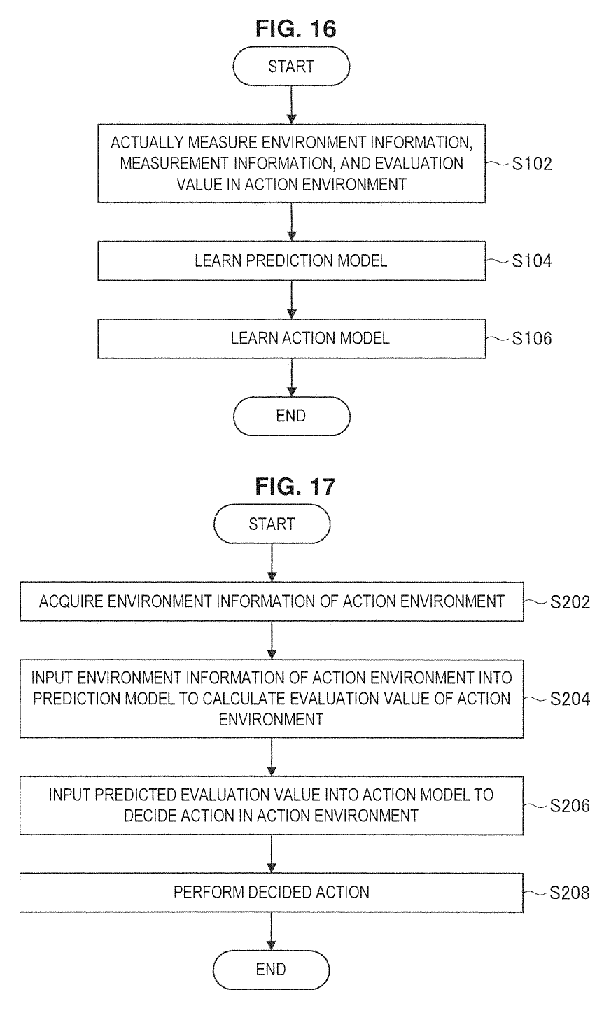

With reference to FIGS. 16 and 17, the following describes an example of the flow of processing by the autonomous mobile object 10.

### Learning Processing

FIG. 16 is a flowchart illustrating an example of the flow of learning processing executed by the autonomous mobile object 10 according to the present embodiment. As illustrated in FIG. 16, first, the autonomous mobile object 10 collects environment information, measurement information, and an evaluation value in an action environment (step S102). For example, the measurement section 152 acquires measurement information in an action environment, and the evaluation section 153 calculates the evaluation value of the action environment on the basis of the acquired measurement information. Then, the storage section 140 stores the measurement information, the evaluation value, and the environment information acquired by the input section 110 in the action environment in association with each other. The autonomous mobile object 10 repeatedly performs this series of processing in various action environments. Then, the learning section 154 learns a prediction model on the basis of these kinds of collected information (step S104), and then learns an action model (step S106).

### Action Decision Processing

FIG. 17 is a flowchart illustrating an example of the flow of action decision processing executed by the autonomous mobile object 10 according to the present embodiment. As illustrated in FIG. 17, first, the input section 110 acquires environment information of an action environment (step S202). Then, the decision section 151 inputs the environment information of the action environment into a prediction model to calculate the evaluation value of the action environment (step S204). Next, the decision section 151 inputs the predicted evaluation value into an action model to decide an action in the action environment (step S206). Then, the decision section 151 outputs the decision content to the drive section 130 to cause the autonomous mobile object 10 to perform the decided action (step S208).

### <3.9. Supplemental Information>

The autonomous mobile object 10 may combine an evaluation value indicating action easiness with an evaluation value other than that to perform learning, decide an action, and the like. For example, the decision section 151 may decide an action of the autonomous mobile object 10 in the action environment further on the basis of at least any of an object recognition result based on a captured image obtained by imaging the action environment or a speech recognition result based on sound picked up in the action environment. On the basis of a result of object recognition, the decision section 151 avoids movement to an environment having a large number of unknown objects, and preferentially decides movement to an environment having a large number of known objects. In addition, on the basis of a speech recognition result of a user's saying “good” or “no,” the decision section 151 avoids movement to an environment for which the user says “no,” and preferentially decides movement to an environment for which the user says “good.”

Needless to say, an object recognition result and a speech recognition result may be input into the prediction model. In other words, an object recognition result and a speech recognition result may be used for a decision of an action according to the action model and a prediction according to the prediction model, or used to learn the action model and the prediction model. In addition, an object recognition result and a speech recognition result may be converted into numeral values, and treated as second evaluation values different from an evaluation value indicating action easiness. A second evaluation value may be, for example, stored in the storage section 140 or displayed in a UI screen.

### 4. CONCLUSION

With reference to FIGS. 1 to 17, the above describes an embodiment of the present disclosure in detail. As described above, the autonomous mobile object 10 according to the present embodiment learns an action model for deciding an action of the autonomous mobile object 10 on the basis of environment information of an action environment, and an evaluation value indicating a cost when the autonomous mobile object 10 takes an action in the action environment. Then, the autonomous mobile object 10 decides an action of the autonomous mobile object 10 in the action environment on the basis of the environment information of the action environment and the learned action model. While learning an action model, the autonomous mobile object 10 can use the action model to decide an action. Thus, the autonomous mobile object 10 can appropriately decide an action in not only a known environment, but an unknown environment, while feeding back a result of an action to the action model. In addition, the autonomous mobile object 10 can update the action model in accordance with the deterioration of the autonomous mobile object 10 over time, a change in an action method, or the like. Therefore, even after these events occur, it is possible to appropriately decide an action.

Typically, the autonomous mobile object 10 decides an action to move a position of high action easiness on the basis of a prediction result of an evaluation value according to the prediction model. This allows the autonomous mobile object 10 to suppress power consumption.

It should be understood by those skilled in the art that various modifications, combinations, sub-combinations and alterations may occur depending on design requirements and other factors insofar as they are within the scope of the appended claims or the equivalents thereof.

For example, in the above-described embodiment, an action body is an autonomous mobile object that autonomously moves on a floor. However, the present technology is not limited to such an example. For example, an action body may be a flying object such as a drone, or a virtual action body that takes an action in a virtual space. In addition, movement of an autonomous mobile object may be not only two-dimensional movement like a floor or the like, but also three-dimensional movement including height.

Each of the apparatuses described herein may be implemented as a single apparatus, or a part or the entirety thereof may be implemented as different apparatuses. For example, in the autonomous mobile object 10 illustrated in FIG. 3, the learning section 154 may be included in an apparatus such as a server connected to the autonomous mobile object 10 via a network or the like. In that case, the prediction model and the action model are learned on the basis of information reported to the server when the autonomous mobile object 10 is connected to the network. The prediction model and the action model may also be learned on the basis of information acquired by the plurality of autonomous mobile objects 10. In that case, it is possible to improve the learning efficiency. In addition, in addition to the learning section 154, at least any of the decision section 151, the measurement section 152, the evaluation section 153, the generation section 155, and the update determination section 156 may also be included in an apparatus such as a server connected to the autonomous mobile object 10 via a network or the like. In addition, an information processing apparatus having the function of the control section 150 may be attachably provided to the autonomous mobile object 10.

Note that the series of processing by each apparatus described herein may be realized by any one of software, hardware, and the combination of software and hardware. A program included in the software is stored in advance, for example, in a recording medium (non-transitory medium) provided inside or outside each apparatus. Then, each program is read by a RAM, for example, when executed by a computer, and is executed by a processor such as a CPU. Examples of the above-described recording medium include a magnetic disk, an optical disc, a magneto-optical disk, a flash memory, and the like. In addition, the computer program described above may also be distributed via a network, for example, using no recording medium.

In addition, the processing described with the flowcharts and the sequence diagrams in this specification need not be necessarily executed in the illustrated order. Some of the processing steps may be executed in parallel. In addition, an additional processing step may be employed, and some of the processing steps may be omitted.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1) A recording medium having a program recorded thereon, the program causing a computer to function as:

a learning section configured to learn an action model for deciding an action of an action body on a basis of environment information indicating a first environment, and action cost information indicating a cost when the action body takes an action in the first environment; and

a decision section configured to decide the action of the action body in the first environment on a basis of the environment information and the action model.

(2) The recording medium according to (1), in which

the decision section predicts the action cost information on a basis of the environment information, the action cost information indicating the cost when the action body takes the action in the first environment.

(3) The recording medium according to (2), in which

the learning section learns a prediction model for predicting the action cost information from the environment information, and

the action cost information is predicted by inputting the environment information into the prediction model.

(4) The recording medium according to (3), in which

the environment information includes a captured image obtained by imaging the first environment, and

the action cost information is predicted for each segmented partial area of the captured image.

(5) The recording medium according to (3) or (4), in which

the action cost information is calculated by comparing first measurement information measured for the action body when the action body takes the action in the first environment with second measurement information measured for the action body when the action body takes an action in a second environment.

(6) The recording medium according to (5), in which

the learning section learns the prediction model to minimize an error between the action cost information obtained from measurement and the action cost information obtained from a prediction according to the prediction model.

(7) The recording medium according to (5) or (6), in which

the first and second measurement information is information based on at least any of moving distance, moving speed, an amount of consumed power, a motion vector including a coordinate before and after movement, a rotation angle, angular velocity, vibration or inclination.

(8) The recording medium according to any one of (5) to (7), the recording medium having a program recorded thereon, the program causing the computer to further function as:

an update determination section configured to determine whether to update the prediction model, on a basis of an error between the action cost information obtained from measurement and the action cost information obtained from a prediction according to the prediction model.

(9) The recording medium according to (8), in which

the update determination section determines whether to update the second measurement information, on a basis of an error between the second measurement information used to calculate the action cost information and third measurement information newly measured in the second environment.

(10) The recording medium according to (8) or (9), in which

the update determination section determines whether to update the second measurement information, on the basis of an error between the action cost information obtained from measurement and the action cost information obtained from a prediction according to the prediction model.

(11) The recording medium according to any one of (2) to (10), in which

the decision section decides an action of the action body in the first environment on a basis of the predicted action cost information.

(12) The recording medium according to any one of (1) to (11), the recording medium having a program recorded thereon, the program causing the computer to further function as:

a generation section configured to generate a display image in which the action cost information for each position is associated with an environment map showing an action range of the action body.

(13) The recording medium according to (12), in which

the decision section decides an action of the action body in the first environment on a basis of the action cost information input according to a user operation on the display image.

(14) The recording medium according to any one of (1) to (13), in which

the learning section performs learning for each action mode of the action body, and the decision section uses the action model corresponding to the action mode to decide an action of the action body.

(15) The recording medium according to any one of (1) to (14), in which

an action of the action body includes movement.

(16) The recording medium according to any one of (1) to (15), in which

the decision section decides whether or not it is possible for the action body to move, and decides a moving direction in a case of movement.

(17) The recording medium according to any one of (1) to (16), in which

the decision section decides an action of the action body in the first environment further on a basis of at least any of an object recognition result based on a captured image obtained by imaging the first environment or a speech recognition result based on speech picked up in the first environment.

(18) An information processing apparatus including:

a learning section configured to learn an action model for deciding an action of an action body on a basis of environment information indicating a first environment, and action cost information indicating a cost when the action body takes an action in the first environment; and

a decision section configured to decide the action of the action body in the first environment on a basis of the environment information and the action model.

(19) An information processing method that is executed by a processor, the information processing method including:

learning an action model for deciding an action of an action body on a basis of environment information indicating a first environment, and action cost information indicating a cost when the action body takes an action in the first environment; and

deciding the action of the action body in the first environment on a basis of the environment information and the action model.

What is claimed is:

1. A recording medium having a program recorded thereon, the program causing a computer to function as:
a learning section configured to learn an action model for deciding an action of an action body on a basis of environment information indicating a first environment, and action cost information indicating a cost when the action body takes an action in the first environment; and
a decision section configured to decide the action of the action body in the first environment on a basis of the environment information and the action model.

2. The recording medium according to claim 1, wherein
the decision section predicts the action cost information on a basis of the environment information, the action cost information indicating the cost when the action body takes the action in the first environment.

3. The recording medium according to claim 2, wherein
the learning section learns a prediction model for predicting the action cost information from the environment information, and
the action cost information is predicted by inputting the environment information into the prediction model.

4. The recording medium according to claim 3, wherein
the environment information includes a captured image obtained by imaging the first environment, and
the action cost information is predicted for each segmented partial area of the captured image.

5. The recording medium according to claim 3, wherein
the action cost information is calculated by comparing first measurement information measured for the action body when the action body takes the action in the first environment with second measurement information measured for the action body when the action body takes an action in a second environment.

6. The recording medium according to claim 5, wherein
the learning section learns the prediction model to minimize an error between the action cost information obtained from measurement and the action cost information obtained from a prediction according to the prediction model.

7. The recording medium according to claim 5, wherein
the first and second measurement information is information based on at least any of moving distance, moving speed, an amount of consumed power, a motion vector including a coordinate before and after movement, a rotation angle, angular velocity, vibration or inclination.

8. The recording medium according to claim 5, the recording medium having a program recorded thereon, the program causing the computer to further function as:
an update determination section configured to determine whether to update the prediction model, on a basis of an error between the action cost information obtained from measurement and the action cost information obtained from a prediction according to the prediction model.

9. The recording medium according to claim 8, wherein
the update determination section determines whether to update the second measurement information, on a basis of an error between the second measurement information used to calculate the action cost information and third measurement information newly measured in the second environment.

10. The recording medium according to claim 8, wherein
the update determination section determines whether to update the second measurement information, on the basis of an error between the action cost information obtained from measurement and the action cost information obtained from a prediction according to the prediction model.

11. The recording medium according to claim 2, wherein
the decision section decides an action of the action body in the first environment on a basis of the predicted action cost information.

12. The recording medium according to claim 1, the recording medium having a program recorded thereon, the program causing the computer to further function as:
a generation section configured to generate a display image in which the action cost information for each position is associated with an environment map showing an action range of the action body.

13. The recording medium according to claim 12, wherein
the decision section decides an action of the action body in the first environment on a basis of the action cost information input according to a user operation on the display image.

14. The recording medium according to claim 1, wherein
the learning section performs learning for each action mode of the action body, and
the decision section uses the action model corresponding to the action mode to decide an action of the action body.

15. The recording medium according to claim 1, wherein
an action of the action body includes movement.

16. The recording medium according to claim 1, wherein
the decision section decides whether or not it is possible for the action body to move, and decides a moving direction in a case of movement.

17. The recording medium according to claim 1, wherein
the decision section decides an action of the action body in the first environment further on a basis of at least any of an object recognition result based on a captured image obtained by imaging the first environment or a speech recognition result based on speech picked up in the first environment.

18. An information processing apparatus comprising:
a learning section configured to learn an action model for deciding an action of an action body on a basis of environment information indicating a first environment, and action cost information indicating a cost when the action body takes an action in the first environment; and
a decision section configured to decide the action of the action body in the first environment on a basis of the environment information and the action model.

19. An information processing method that is executed by a processor, the information processing method comprising:
learning an action model for deciding an action of an action body on a basis of environment information indicating a first environment, and action cost information indicating a cost when the action body takes an action in the first environment; and
deciding the action of the action body in the first environment on a basis of the environment information and the action model.
